(19) United States
(12) Patent Application Publication
(10) Pub. No.: US 2012/0269517 A1
(43) Pub. Date: Oct. 25, 2012

(54) Method and Means of Eliminating Wiring Harness in High-Speed and High-Precision Machines

(75) Inventor: Jahangir S. Rastegar, Stony Brook, NY (US)

(73) Assignee: Omnitek Partners LLC, Ronkonkoma, NY (US)

(21) Appl. No.: 13/277,192

(22) Filed: Oct. 19, 2011

Related U.S. Application Data
(60) Provisional application No. 61/405,181, filed on Oct. 20, 2010.

(51) Int. Cl. H04B 10/10; H02J 17/00

(52) U.S. Cl. 398/130; 307/104

(57) ABSTRACT

A method for wirelessly providing electrical energy to a moving platform that is movable relative to a base or ground structure. The method including: moving the moving platform relative to the base or ground structure; providing a device on the moving platform for converting a first energy to the electrical energy; directing a source of the first energy at the device; converting the first energy to the electrical energy at an output of the device; and providing the electrical energy to one or more of an electrical or electronic device associated with the moving platform or to an energy storage device associated with the moving platform. The method can further include wirelessly transmitting data between the moving platform and the base or ground structure.

### CROSS-REFERENCE TO RELATED APPLICATIONS

This application claims benefit to U.S. Provisional Application No. 61/405,181 filed on Oct. 20, 2010, the contents of which are incorporated herein by reference.

### BACKGROUND

1. Field

The present application relates generally to purely optical power transfer to and one or two-way data communication with moving platforms of machines, and more particularly, to moving platforms of high-speed and/or ultra-high precision machinery, for the primary reason of eliminating wiring harnesses for these purposes, thereby reducing the mass of the moving platforms and eliminating the forces transmitted via such wiring harnesses to the moving platforms, which has the significant benefit of reducing the achievable speed and precision by the moving platforms.

2. Prior Art

Moving platforms of machinery typically require electrical energy to power their electrical components such as components performing various tasks specific to the machinery or for powering other moving platforms riding on the platform such as serially operating linear and/or rotary stages. Electrical power is also required to power various sensors, electronic circuitry, processors, control circuitry, etc., commonly used in various machinery, including manufacturing and other types of machinery or machines. In addition, data (sensory, control signals generated by the system processors, feedback signals, etc.), needs to be transferred to and usually from the moving platforms to the system controls and the like, which are usually fixed relative to the base structure of the machine, which is in most cases is fixed to the ground. Data is also usually required to be transferred back and forth between all moving components, including the aforementioned other moving platforms riding on the first moving platform such as serially operating linear and/or rotary stages. Hereinafter, the aforementioned first and other serially operating linear and or rotary or other types of stages and other moving components are collectively referred to as the “moving platforms”. Similarly, hereinafter, all electrical, electronic, optical, electromagnetic, processors, etc., that utilize electrical energy for their operation and/or communicate data (in a one-way and/or two-way mode) are collectively referred to as “electrical and electronic” components, which may be fixed to any one of the aforementioned “moving platforms” of the machinery and the like.

In current machinery, the aforementioned wiring for supplying electrical power to the aforementioned “electrical and electronic” components on the aforementioned “moving platforms” is accomplished by wiring and sometimes fiber optics, which are usually bundled together as wiring harnesses to make them more manageable. Such wiring (wiring harnesses) that are connected to the various moving platforms of a machine need to extend over the entire range of motion of the machine, a task that in some machines is achieved by using “collecting” wheels, flexible conduits, coiled bundles, etc. In all such existing methods, the wiring (wiring harness), mostly using copper conductors, apply a considerable and varying force and/moment and/or torque (hereinafter collectively referred to as the force) to the moving platform due to its weight and due to its unavoidable friction forces while interacting with the environment. The application of such external and varying inertia, the generated inertia and friction forces, and the addition of such inertia with their required high level of flexibility and the resulting and unavoidable modes of vibration to the moving platform causes significant vibration and control problems to such machines and significantly affect their performance in terms of operating speed and precision that they can achieve. When possible and for machines with relatively small movements, the wiring harness may be brought to the moving platform vertically to minimize friction and the inertia as seen by the moving platform. This configuration, however, even though it can be helpful in reducing the vibration and control problems, does not eliminate the problem, and still provides limitations on the achievable speed, dynamic response and precision that can be achieved.

It is noted that in many machinery used in the electronics fabrication and assembly and optics components manufacturing and the like, and at very high costs, efforts are made to reduce the inertia of the moving platforms while enhancing the stiffness of the machine structure and eliminate friction forces using air bearings and/or magnetic levitation to achieve higher operating speeds and dynamic response as well as higher precision. However, the aforementioned presence of wiring harnesses for power and data communication has limited the achievable speed, dynamic response and precision of these machines.

It is noted that one and/or two-way communications using Radio Frequency (RF) transmitters and receivers have been used for one and/or two-way communications with components on moving platforms. In addition, electrical energy has also been transmitted wirelessly to various moving platforms using RF signals. The amount of power that can be transferred to components on moving platforms via RF signals is very low and in most cases not enough to power sensory devices and their electronics. The data communications via RF signals is very commonly used, but is prone to interference and interruptions, particularly in a manufacturing environment in a crowded plant with various machinery and other electrical and electronic equipment running.

A need therefore exists for methods and devices for transferring electrical energy to moving platforms of machinery without the use of aforementioned wiring harnesses.

A need also exists for methods and devices for one and/or two way communication with the moving platforms without the use of direct wiring or RF transmission.

### SUMMARY

It is an object of the present invention to provide the moving platforms in various machinery with large enough electrical power without wiring to power their electrical, electronics, sensory, processing, and other electric energy consuming components.

It is another object of the present invention to provide the moving platforms in various machinery with high-rate and highly reliable one and/or two-way means of data communication without wiring for their electrical, electronics, sensory, processing, and other components.

Accordingly, optical methods and means are provided to transmit energy and/or one-way and/or two-way data through open space to moving platforms of machinery in general, and to high-speed and ultra-high precision in particular. The optical means of transmitting energy can be a laser, which is transmitted to receiving means that transform the laser provided energy to electrical energy. The means of transforming laser energy to electrical energy can be thermophotovoltaic (TPV) cells, which are tuned to efficiently absorb the optical energy and convert it to electrical energy. The TPV and laser technology that can be used for this purpose is well known in the art. Hereinafter, the optical (laser) source(s) used for optically transmitting power from onto the TPV cell(s) is generally referred to as the “charging laser source” and the receiving element(s) is generally referred to as the “TPV cell”.

During the motion of the electrical energy receiving moving platform, the laser spot(s) is kept positioned over the laser energy to electrical converting (such as the TPV) cell(s), such as by a servo controlled “optical scanning mirror” device(s) or the like, hereinafter referred to collectively as “laser scanning head”. The transferred electrical energy may be used directly or stored in electrical energy storage devices such as rechargeable batteries or capacitors.

The data can also be transmitted to the moving platform optically by either modulating the energy transmitting laser source or by using a separate (usually significantly lower power) optical source such as laser or infra-red (IR) to establish a one-way or a two-way means of data communication.

### BRIEF DESCRIPTION OF THE DRAWINGS

These and other features, aspects, and advantages of the apparatus and methods of the present invention will become better understood with regard to the following description, appended claims, and accompanying drawings where:

FIG. 1 illustrates a schematic of an embodiment of a system of the present application.

FIG. 2 illustrates the system of FIG. 1.

### DETAILED DESCRIPTION

Although the invention is particularly suited to the elimination of wiring harnesses used to transmit electrical power and for providing for one-way and two-way data transmission in high-speed and high-precision machinery, such is discussed by way of example only. Those skilled in the art will appreciate that the disclosed method and means of transmitting power to moving platforms and methods and means for one-way and two-way data transmission to said moving platforms may be employed between two bodies with relative motion, one of such bodies may be stationary as described in the present example of high-speed and high-precision machinery.

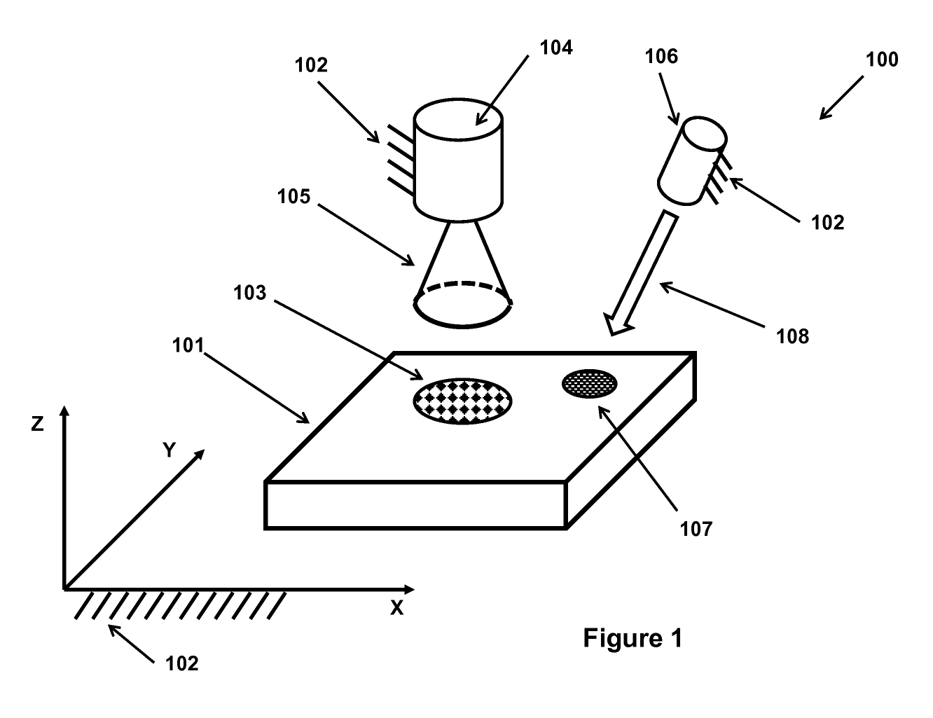

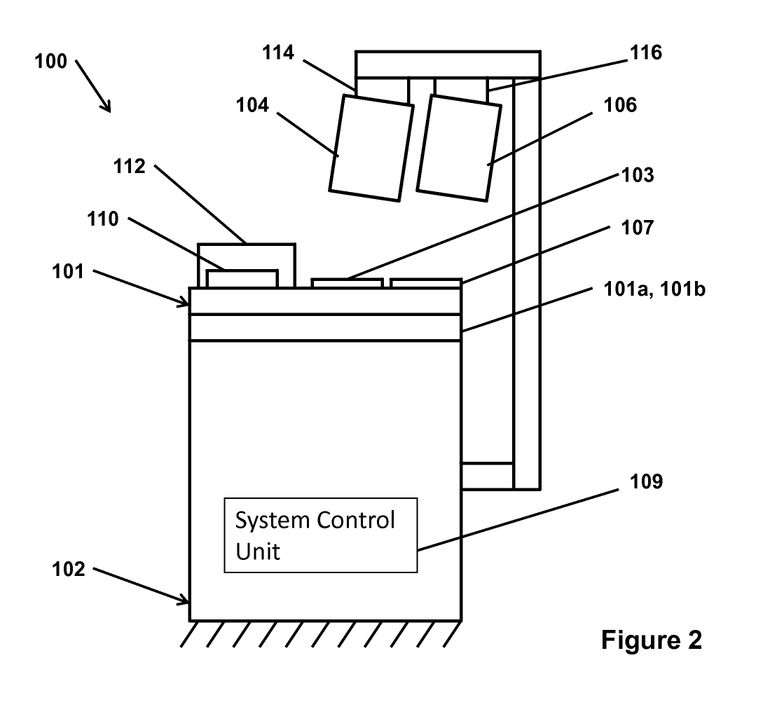

Referring now to FIGS. 1 and 2, there is shown a typical moving platform 101 of a machine 100 (only the moving platform of which is shown in FIG. 1), in this case a moving platform (stage) 101 is considered to be capable of planar translation in two independent directions, indicated in the Figure as the XY plane of the Cartesian XYZ coordinate system, such as by stage motor 101a for movement in the X direction and stage motor 101b for movement in the Y direction. The Cartesian XYZ coordinate system is considered to be fixed to the base structure of the machine (100), which is usually fixed to the ground 102. Here it is assumed that the moving platform 101 translates over the surface of the plane XY of the Cartesian coordinate system XYZ, riding over certain sliding joints (not shown) that could consist of two sets of serially attached rails with an intermediate member or via air bearings or magnetic bearings, or any other methods of achieving a two degree-of-freedom translational motion of the moving platform 101 with respect to (parallel to) the XY plane of the Cartesian XYZ coordinate system.

In current machinery and the like, electrical power to drive various electrical and electronic components that are located on the moving platform 101 (fixed or moving relative to the moving platform 101), as well as the sensory, motion planning, control signals, and other data are transmitted to the moving platform 101 from the ground 102 or the base (grounded) structure via one or more wire harnesses.

At least one TPV cell 103 (for example, the Photovoltaic power converters (PPC), for example those from JDSU of Milpitas, Calif. is attached to the moving platform 101. At least one commercially available motorized mirror based scanner or the like 104 (i.e., the aforementioned laser scanning head) is used to scan a laser beam 105 (in FIG. 1 indicated by a cone 105—representing a two rotational degrees-of-freedom of laser beam pointing) such that the laser beam 105 is always pointed onto a TPV cell 103. Such motorized mirror based scanners that could be used include those commercially available from Blue Hill Optical Technologies, located in Norwood, Mass. or Nutfield Technology, Windham, N.H.

The laser source(s) of the at least one laser scanning head and the corresponding TPV cell(s) is preferably tuned for efficient absorption of the optical energy by the TPV cells and its conversion to electrical energy.

The laser beam 105 from the laser scanning head 104 can be pointed onto the TPV cell 103 at all times while the moving platform moves relative to the base structure (ground) 102. The optical energy transferred from the laser beam 105 is then transformed into electrical energy and used directly by electrical, electronics, and other electrical energy consuming elements (generally referred to by reference numeral 110) associated with the moving platform 102 or is stored in electrical energy storage devices (generally referred to by reference numeral 112) such as capacitors or rechargeable batteries associated with the moving platform.

The direction of the laser beam of commonly available laser scanning heads such as those indicated previously are usually controlled by a microprocessor (hereinafter referred to as the “laser beam control unit”) that gets its control command from the system (in this case the machine 100) control unit (usually a computer with at least one processor and sometimes with Digital Signal Processing (DSP) units or the like for real-time process control). Hereinafter, the system control unit and all its hardware and software components are referred to as simply the “system control unit” 109. Such system control unit 109 is shown schematically in FIG. 2 and is assumed to be operatively and electrically connected to the components of the machine 100.

In general, the beam 105 from a laser scanning head 104 is ensured to be pointed onto the TPV cell 103 as the moving platform 101 moves by commands sent from the system control unit 109 to the laser beam control unit (considered to be either integral with the system control unit 109 or the laser scanner 104, but can be provided separate therefrom). This is made possible since the system control unit 109 is responsible for planning and executing motions of the moving platform 101. The system control unit 109 is therefore aware of the position of the moving platform 101 relative to the base structure 102 of the machine, i.e., in the Cartesian XYZ coordinate system at all times. In cases in which at least one of the actuation devices (stage motors 101a, 101b) that are used to drive the moving platform 101 is mounted on the moving platform 101 or the position sensory information is available only on the moving platform 101, then such (sensory or the like) information indicating the actual position of the moving platform 101 relative to the base structure 102 of the machine 100 (i.e., in the Cartesian XYZ coordinate system) is provided directly to the laser beam control unit. In addition (or alternatively, particularly if the motion of the moving platform 101 is relatively slow), the voltage generated by the TPV cell 103 can be used to allow the laser beam control unit to keep the laser beam as closely pointed onto the TPV cell 103 as possible. It is noted that most TPV cells are constructed with multiple such cell units that are interconnected in appropriate manner to provide the desirable voltage and/or current. For this reason, from the voltage reading of the individual cells on a TPV cell, it is possible for the laser control unit to determine in which way the laser beam must be moved to bring it back essentially pointed directly (centrally) onto the TPV cell.

It is appreciated by those skilled in the art that most laser scanning heads provide for a relatively limited range of laser beam deflection in two directions (for the two degree of rotational degrees-of-freedom laser scanning head 104 shown in FIG. 1—which is considered to provide beam rotational deflection about the axes X and Y). Such limitations in the range of rotational deflections that can be provided by laser scanning heads 104 (usually up to ±25 degrees) and the distance at which the moving platform 101 is positioned away from the laser scanning head 104 determines the range of moving platform 101 motion within which the laser scanning head can keep the laser beam pointed onto the TPV cell 103. If the range of motion of the moving platform 101 is larger than can be accommodated with a single laser scanning head 104, then several options exists that can be used to provide electrical energy to the moving platform 101 by the aforementioned laser energy and TPV cells, including the following.

It is appreciated by those skilled in the art that during the motion of the moving platform 101, at certain positions, the path of travel of the laser beam 105 towards the target TPV cell may become blocked due to the presence of certain obstacles. The presence of such obstacles may also be addressed using one of the following embodiments.

In one such embodiment, the laser scanning head 104 is allowed to be moved (either continuously or in steps) on a parallel one or two degrees-of-freedom stage 114 (depending on the range of motion of the moving platform in each direction) so that the entire range of motion of the moving platform could be covered by each at least one pair of laser scanning head 104 and TPV cell 103.

It is appreciated by those skilled in the art that the aforementioned parallel stage 114 for proper positioning of the laser scanning head 104 relative to the TPV cells 103 may be provided with more than one or two translational degrees-of-freedom to cover almost any arbitrary translational and/or rotational motion of the moving platform 101.

In an alternative embodiment, more than one laser scanning head 104 are positioned at proper distances to allow at least one of the laser scanning heads 104 to be capable of pointing its laser beam onto each TPV cell 103 for the entire range of motion of the moving platform 101.

In yet another alternative embodiment, more than one TPV cells 103 are provided on the moving platform 101 for each laser scanning head 104 and are positioned at proper distances to allow the laser scanning heads 104 to be capable of pointing its laser beam onto at least one TPV cell 103 for the entire range of motion of the moving platform 101.

It is appreciated by those skilled in the art that the TPV cell 103 may also be provided with the means, preferably motorized rotational stages (not shown), that could be used to keep the TPV cells 103 as closely aligned with the incoming laser beam as possible to increase the efficiency with which the optical energy is absorbed by the TPV cells 103 and converted to electrical energy.

In addition, the same laser (or other optical) source used by the laser scanning head to transmit energy onto the aforementioned TPV cells 103 may be used to modulate the laser beam 105 to also transmit data to the moving platform 101, such as sensory or command and control data. The modulated signal can then be received by the same optical energy to electrical energy conversion device (preferably the aforementioned TPV cells) and then passed to the interior electronics, data storage, processor or the like (hereinafter referred to as the “moving platform” alone) directly or through an existing communications bus (not shown). It is noted, however, that this means of data transmission is one-way, i.e., data can only be transmitted to the moving platform 101 from the base structure of the machine or ground 102.

Alternatively, IR technology may be used to establish one-way or two-way data communication with the moving platform. IR technology is well known in the art, particularly in the art of remote control of electronic consumer goods. The IR data association (IrDA®) has standards for communicating data via short-range infrared transmission. Transmission rates fall within three broad categories SIR, MIR and FIR. SIR (Serial Infrared) speeds cover transmission speeds normally supported by an RS-232 port. MIR (Medium Infrared) usually refers to speeds of 0.576 Mb/s to 1.152 Mb/s. FIR (Fast Infrared) denotes transmission speeds of about 4 Mb/s. The standard has been modified for faster transmission speeds up to 16 Mb/s (referred to as very fast Infrared VFIR).

In one embodiment, one IR transceiver module 106 is mounted to the base structure 102 of the machine 100 or ground 102 and one IR transceiver module 107 is mounted on the moving platform 101 as shown in the schematic of FIG. 1. The two transceiver modules can then be used to establish a two-way communication link between the base structure of the machine or ground and the moving platform 101. An example of such transceiver modules 106 and 107 is the (IrDA®) transceiver manufactured by Sharp Inc. (2P2W1001YP) which is relatively inexpensive and contains a high speed, high efficiency low power consumption light emitting diode (LD), a silicon PIN photodiode (PD) and a low power bipolar integrated circuit. The circuit contains an LED driver (TRX) and a receiver circuit (RCX) that delivers 4 Mb/s operation for distances of 1 meter. The LED emitter transmits at a nominal wavelength of 880 nm with a radiant intensity in the range of 100 to 500 mW·sr⁻¹ with a radiation angle of +/−15 degrees. The pin photodiode has an integrated amplifier (AMP) and comparator (CMP), which provides a fixed voltage output over a broad range of input optical power levels and data rates.

In general, if the range of motion of the moving platform 101 is relatively small, the transceiver modules 106 and 107 will stay within their communications range. For example, for the above +/−15 degrees of IR radiation angle for each transceiver 106 and 107 and considering that the two transceivers are 1 m apart, then if the moving platform moves within a circle of slightly over 0.5 m in diameter (considering that the transceivers were initially facing each other vertically), then they would still be in their full communication range. However, if the range of motion of the moving platform is larger, a method of preventing the communications link from being broken or interrupted is to use more than one transceiver module 106 and space them appropriately so that their overlapping range would cover the entire range of motion of the moving platform. It is noted that the latter method keeps the communications link uninterrupted since IR transceiver modules are very inexpensive and since the machine control system at all times knows where the moving platform 101 is, it could readily activate the transceiver module that is within the range of the transceiver module 107 of the moving platform. Other options include the mounting of the transceiver module 106 on a rotating head 116 with at least one rotational (or translational instead of rotational) degree-of-freedom so that the transmitted/received beam 108 could be rotated/translated such that it would always stay in the range of each transceiver 106 and 107.

It is appreciated by those skilled in the art that a pair of IR transmitter and receiver modules may be used to replace the transceiver modules 106 and 107 to provide a one-way communication link between the moving platform 101 and the base structure of the machine or the ground 102. This option may, for example be chosen for transmitting data from the moving platform 101 by replacing the IR transceiver module 107 by an IR transmitter module and the IR transceiver module 106 by an IR receiver to establish a one-way data transmission link and transmitting data from the moving platform to the base structure of the machine or the ground 102. This option is particularly warranted if data from the base structure of the machine or the ground 102 is being transmitted by the modulated laser beam 105 of the laser scanning head 104 as was previously described.

Alternatively, RF transceivers (or pairs of RF transmitters and receivers) may be used to provide a one-way or two-way communications link between the moving platform 101 and the base structure of the machine or the ground 102. Such RF-based method and devices (transmitters and receivers and transceivers) for establishing one-way or two-way communications link between moving objects are well known in the art. In an environment with multiple machines and/or other electrical and electronics and RF devices, such RF means of providing vital (most probably needed for machine and process control) and relatively high-rate communications link, however, may not be suitable due to the ever present noise and possibility of interference, etc. For this reason, a dedicated (shorter range IR) would in most situations be the preferable method of establishing the required communications link between the moving platform and the base structure of the machine or the ground 102.

It is appreciated by those skilled in the art that even though the application of the disclosed embodiments were described for a machine with two translational degree-of-freedom (motion in the XY plane) shown in the schematic of the Figure, the disclosed methods and devices are applicable to all types of machinery with more degrees-of-freedom (both translational and rotational). In addition, the machine may have other moving platforms riding on the moving platform 101, the Figure, i.e., the machine may have been constructed with several in-series (or in-parallel or the combination of in-series and in-parallel) stages. In which case, the disclosed methods and devices may similarly be used to transmit power and data to each moving platform from the base structure of the machine or the ground 102 or even from other moving platforms. In addition, similar one-way or two-way IR communications links may be established between each moving platform and the base structure of the machine or the ground 102 or even from other moving platforms.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. A method for wirelessly providing electrical energy to a moving platform that is movable relative to a base or ground structure, the method comprising:
moving the moving platform relative to the base or ground structure;
providing a device on the moving platform for converting a first energy to the electrical energy;
directing a source of the first energy at the device;
converting the first energy to the electrical energy at an output of the device; and
providing the electrical energy to one or more of an electrical or electronic device associated with the moving platform or to an energy storage device associated with the moving platform.

2. The method of claim 1, wherein the device converts light energy to electrical energy.

3. The method of claim 2, wherein the light energy is a laser and the source is a laser generation device.

4. The method of claim 4, further comprising maintaining the directing even though the moving platform moves relative to the base or ground structure.

5. The method of claim 1, wherein the maintaining comprises providing the device on an area of the moving platform such that the source is always incident on the device throughout a range of movement of the moving platform.

6. The method of claim 4, wherein the maintaining comprises providing one or more of the source or device to be movable relative to the base.

7. The method of claim 1, further comprising wirelessly transmitting data between the moving platform and the base or ground structure.

8. The method of claim 7, wherein the wirelessly transmitting data comprises modulating the first energy.

9. The method of claim 8, wherein the first energy is a light energy.

10. A method for wirelessly transmitting data to a moving platform that is movable relative to a base or ground structure, the method comprising:
moving the moving platform relative to the base or ground structure;
providing one or more of a first transceiver or a receiver on the moving platform for receiving data;
directing a signal source at the device from one or more of a second transceiver or a transmitter;
processing a signal from the signal source; and
providing data contained in the signal to one or more electrical or electronic device associated with the moving platform.

11. The method of claim 10, further comprising maintaining the directing even though the moving platform moves relative to the base or ground structure.

12. The method of claim 10, wherein the maintaining comprises providing the device on an area of the moving platform such that the signal is always incident on the device throughout a range of movement of the moving platform.

13. The method of claim 10, wherein the maintaining comprises providing one or more of the signal or device to be movable relative to the base.

14. The method of claim 10, further comprising wirelessly transmitting electrical energy to the moving platform.

15. The method of claim 14, wherein the wirelessly transmitting the electrical energy comprises:
providing a device on the moving platform for converting a first energy to the electrical energy;
directing a source of the first energy at the device;
converting the first energy to the electrical energy at an output of the device; and
providing the electrical energy to one or more of the electrical or electronic device associated with the moving platform or to an energy storage device associated with the moving platform

16. The method of claim 15, wherein the signal and the first energy is a light energy.
